(19) United States
(12) Patent Application Publication
(10) Pub. No.: US 2020/0242703 A1
(43) Pub. Date: Jul. 30, 2020

(54) BLOCKCHAIN PAYROLL SYSTEM

(71) Applicant: ADP, LLC, Roseland, NJ (US)

(72) Inventors: Roberto Masiero, Basking Ridge, NJ (US); Fabiano Pereira, Porto Alegre (BR)

(21) Appl. No.: 16/258,195

(22) Filed: Jan. 25, 2019

(51) Int. Cl. G06Q 40/00; G06F 16/28

(52) U.S. Cl. CPC G06Q 40/125; G06F 16/28

(57) ABSTRACT

A method, a computer system, and a computer program product are provided for providing payroll services by separately managing payroll information for employers and employees. A payroll blockchain system records a payroll services smart contract on a payroll block chain. The payroll services smart contract indicates an employer and at least one condition for processing payroll for the employer. In response to occurrence of the condition for processing payroll for the employer, payroll blockchain system identifies employer payroll information recorded in an employer smart contract on the payroll block chain. Payroll blockchain system identifies employee payroll information recorded in an employee smart contract on a payroll block chain. Payroll blockchain system processes payroll for the employer based on the employer payroll information and is recorded in the employer smart contract, and the employee payroll information recorded in an employee smart contract.

### BACKGROUND INFORMATION

### 1. Field

The present disclosure relates to use of payroll smart contracts implemented solely in a computer network for use with distributed ledgers.

### 2. Background

A distributed ledger, as used throughout this document, refers to a computer-only technology that enables a distributed recordation of transactions through the distributed ledger maintained by a network of computers. A blockchain is an example of a distributed ledger. BITCOIN® is an example of a blockchain technology application.

A blockchain is a type of distributed ledger, which includes digitally-recorded, unmodifiable data in packages called blocks. A distributed ledger is a consensus of replicated, shared, and synchronized digital data geographically spread across multiple computers which may be in different sites, countries, and/or institutions maintained by many different parties. A distributed ledger can be public, such as BITCOIN®, where there is no limitation on who may participate in the network, or private, where only approved parties are permitted to participate in the network.

### SUMMARY

The illustrative embodiments provide for a method for controlling access to a licensed software application. A computer system receives an access request from a user that requests access to the licensed software application. The computer system determines whether a user has accepted license terms for a current version of the licensed software application by querying a version control blockchain. Responsive to determining that user has not accepted the license terms for the current version of the licensed software application, the computer system presents the user with a clickwrap agreement requiring the user to accept license terms for the current version of the licensed software application. Responsive to receiving acceptance of the license terms from the user, the computer system records the user's acceptance of the license terms for the current version of the licensed software application in the version control blockchain.

The illustrative embodiments also contemplate a computer configured to execute program code which implements this method. The illustrative embodiments also contemplate a non-transitory computer-recordable storage medium storing program code, which, when executed, implements this method.

### BRIEF DESCRIPTION OF THE DRAWINGS

The novel features believed characteristic of the illustrative embodiments are set forth in the appended claims. The illustrative embodiments, however, as well as a preferred mode of use, further objectives and features thereof, will best be understood by reference to the following detailed description of an illustrative embodiment of the present disclosure when read in conjunction with the accompanying drawings, wherein:

FIG. 1 is a distributed ledger in the form of a blockchain in accordance with an illustrative embodiment;

FIG. 2 is a first step in creating a blockchain in accordance with an illustrative embodiment;

FIG. 3 is a second step in creating a blockchain in accordance with an illustrative embodiment;

FIG. 4 is a third step in creating a blockchain in accordance with an illustrative embodiment;

FIG. 5 is a fourth step in creating a blockchain in accordance with an illustrative embodiment;

FIG. 6 is a fifth step in creating a blockchain in accordance with an illustrative embodiment;

FIG. 7 is a sixth step in creating a blockchain in accordance with an illustrative embodiment;

FIG. 8 is a creation of a smart contract in accordance with an illustrative embodiment;

FIG. 9 is an operation of a smart contract in accordance with an illustrative embodiment;

FIG. 10 is a block diagram of an execution environment for executing a smart contract stored on a blockchain in accordance with an illustrative embodiment;

FIG. 11 is a block diagram of a blockchain environment in accordance with an illustrative embodiment;

FIG. 12A is a block diagram illustrating a first step in a data flow for updating payroll information in accordance with an illustrative embodiment;

FIG. 12B is a block diagram illustrating a second step in a data flow for updating payroll information in accordance with an illustrative embodiment;

FIG. 12C is a block diagram illustrating a third step in a data flow for updating payroll information in accordance with an illustrative embodiment;

FIG. 13 is a flowchart of a process for providing payroll services by separately managing payroll information for employers and employees in accordance with an illustrative embodiment; and

FIG. 14 is a block diagram of a data processing system in accordance with an illustrative embodiment.

### DETAILED DESCRIPTION

The illustrative embodiments recognize and take into account that smart contracts on blockchains have not been used to track employee working hours. In other words, thus far, no one has attempted or designed a timeclock system that utilizes the underlying technology of blockchains and smart contracts to create an open and secure timeclock system.

A distributed ledger, as used throughout this document, refers to a computer-only technology that enables the distributed recordation of transactions through a distributed ledger maintained by a network of computers. A distributed ledger is a consensus of replicated, shared, and synchronized digital data geographically spread across multiple computers which may be in different sites, countries, and/or institutions maintained by many different parties. A blockchain is an example of a distributed ledger.

A blockchain is a type of distributed ledger, which includes digitally recorded, unmodifiable data in packages called blocks. Stated more formally, a blockchain is a distributed database that maintains a continuously growing list of ordered records called blocks. Each block contains a timestamp and a link to a previous block, with the hash of the prior block linking the two. By design, blockchains are inherently resistant to modification of the data because, once recorded, the data in a block cannot be altered retroactively. Through the use of a peer-to-peer network and one or more distributed timestamping servers, a blockchain database may be managed autonomously. Thus, blockchains may be used to provide an open, distributed ledger that can record transactions between parties efficiently and in a verifiable and permanent way.

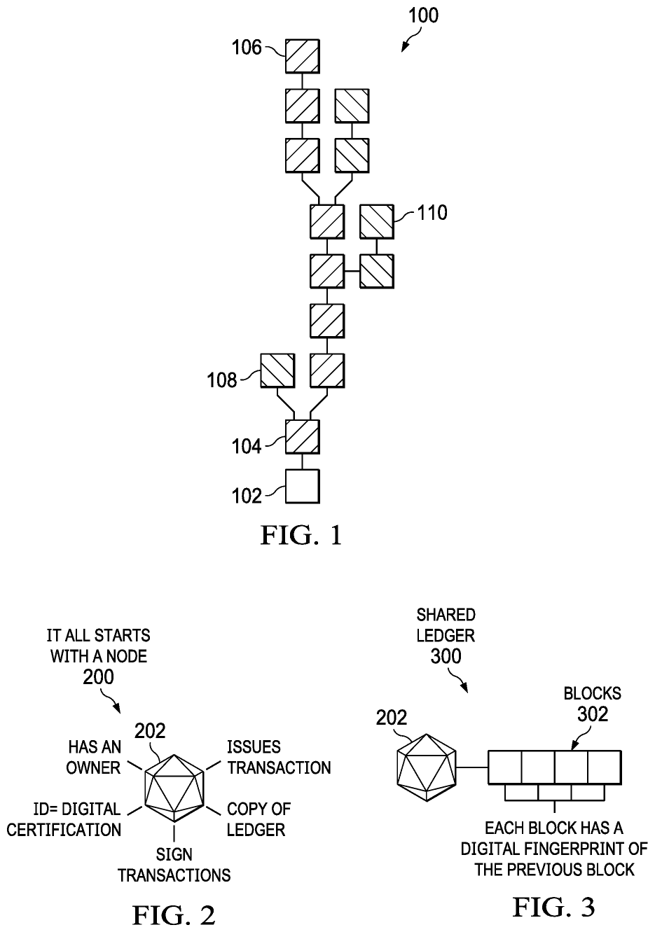

FIG. 1 is an illustration of a distributed ledger in the form of a blockchain depicted in accordance with an illustrative embodiment. Blockchain 100 is a blockchain, which is a specific implementation of a distributed ledger. Blockchain 100 is described to introduce blockchain concepts.

Blockchain 100 starts with genesis block 102. Blocks indicated with a right-leaning hash, such as block 104 or block 106, are part of the main chain. Blocks with a left-leaning hash, such as block 108 or block 110, exist outside of blockchain 100.

Thus, blockchain 100 is a heaviest path from root block 102 to leaf block 106 through the entire block tree. The “heaviest” path through the block tree, i.e. the path that has had the most computation done upon it, is conceptually identified as blockchain 100. Identifying blockchain 100 in this manner allows a decentralized consensus to be achieved for the state of blockchain 100.

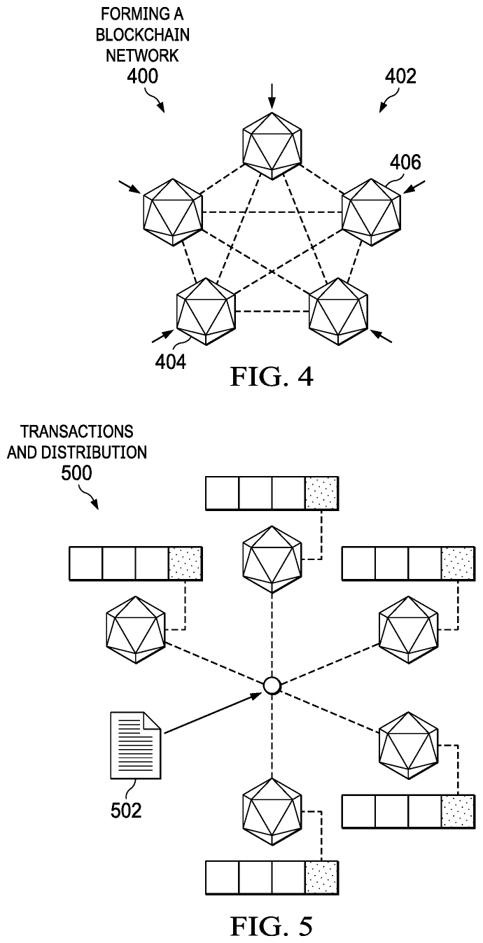

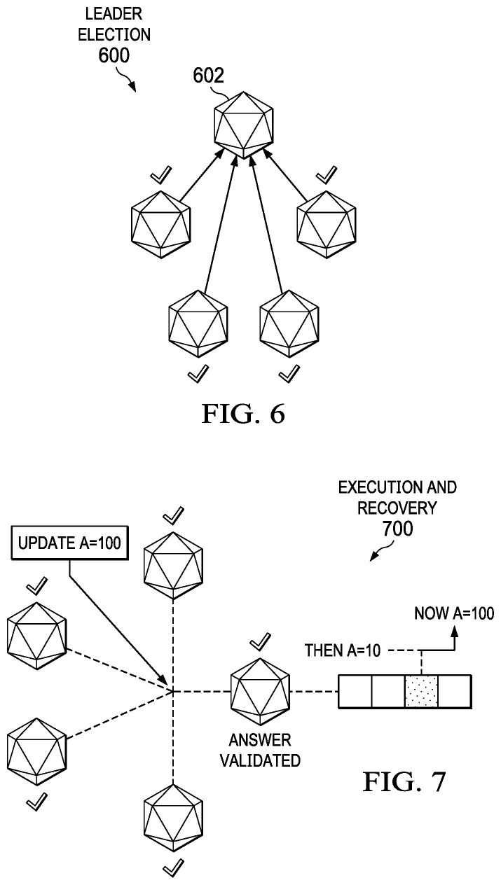

FIG. 2 through FIG. 7 should be considered together. FIG. 2 is an illustration of a first step in creating a blockchain in accordance with an illustrative embodiment. FIG. 3 is an illustration of a second step in creating a blockchain in accordance with an illustrative embodiment. FIG. 4 is an illustration of a third step in creating a blockchain in accordance with an illustrative embodiment. FIG. 5 is an illustration of a fourth step in creating a blockchain in accordance with an illustrative embodiment. FIG. 6 is an illustration of a fifth step in creating a blockchain in accordance with an illustrative embodiment. FIG. 7 is an illustration of a sixth step in creating a blockchain in accordance with an illustrative embodiment. FIG. 2 through FIG. 7 may be implemented on a computer or on multiple computers in a network environment. FIG. 2 through FIG. 7 address a technical problem that only exists in computer programming and execution. As used throughout FIG. 2 through FIG. 7, common reference numerals refer to common objects in these figures.

In operation 200 shown in FIG. 2, account 202, also sometimes referred to as a “node,” is a state object recorded in a shared ledger that represents the identity of agents that can interact with the ledger. Account 202 includes an owner, a digital certificate identification, and a copy of a ledger. Account 202 may sign transactions and inspect the blockchain and its associated state. A user may issue transactions, signed by account 202, to interact with the blockchain. The combined state of all accounts that have interacted with the blockchain is the state of the blockchain.

In operation 300 shown in FIG. 3, account 202 collates transactions and distributions into blocks 302, and adds blocks 302 to the shared ledger. Blocks 302 function as a journal, recording a series of transactions together with the previous block and an identifier for the final state of the blockchain. Blocks 302 are chained together using a cryptographic hash as a means of reference—each block in the shared ledger has a digital fingerprint of the previous block. In this manner, it is not possible to alter previous blocks without being detected.

In operation 400 shown in FIG. 4, blockchain network 402 is formed. Blockchain network 402 may include multiple local copies of blockchains such as those shown in FIG. 2 or FIG. 3. Each account, such as account 404 or account 406, has its own blockchain.

In operation 500 shown in FIG. 5, transaction 502 is issued from an account, such as account 202 in FIG. 2. Transaction 502 is an instruction constructed and cryptographically-signed by an account, such as account 204.

Transaction 502 can result in message calls to other accounts. Transactions that result in message calls contain data specifying input data for the message. Alternatively, transaction 502 can result in the creation of new agent accounts, i.e., “contract-creation” transactions.

Transactions are collated into blocks that are added to local blockchain copies by the various accounts. The blockchain is synchronized across the various nodes. Thus, each account in blockchain network 402 in FIG. 4 adds identical blocks to a local copy of the blockchain.

In operation 600 shown in FIG. 6, leader election takes place. Leader account 602 takes priority for deciding which information is the most accurate or up-to-date. Identifying information by leader account 602, and validating this information by other accounts, allows a decentralized consensus to be achieved throughout the network for the state of blockchain 100 in FIG. 1.

In operation 700 shown in FIG. 7, data execution and recovery take place. A query regarding data stored in one or more of the nodes may return a validated answer regarding contents in the blocks.

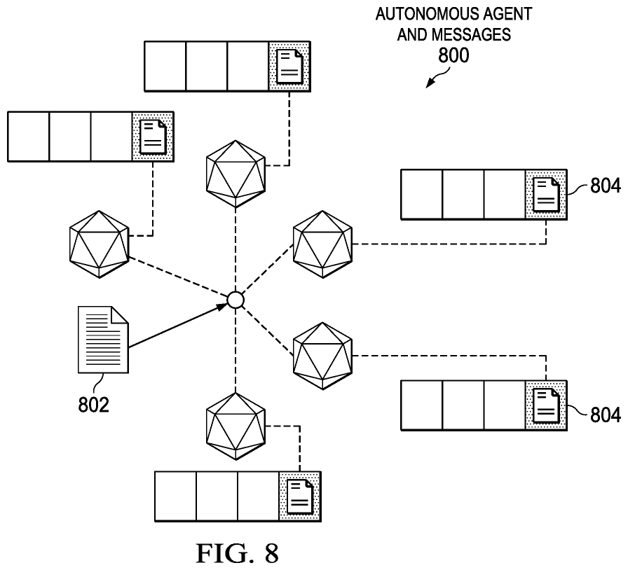

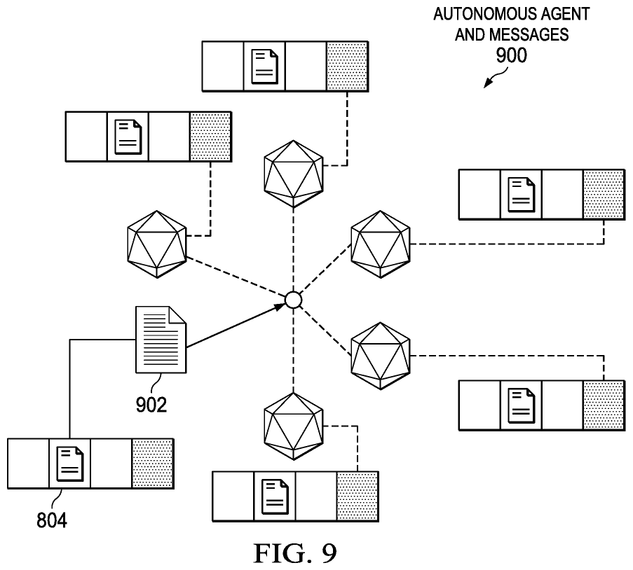

FIG. 8 and FIG. 9 should be considered together. FIG. 8 is an illustration of a step in creating a smart contract within a blockchain in accordance with an illustrative embodiment. FIG. 9 is an illustration of a step in creating a blockchain using a smart contract within a blockchain in accordance with an illustrative embodiment. FIG. 8 and FIG. 9 may be implemented on a computer or on multiple computers in a network environment.

In operation 800 shown in FIG. 8, transaction 802 is a “contract-creation” transaction that results in the creation of smart contract 804. In contrast to data contained in message call transactions, such as transaction 502 in FIG. 5, transaction 802 contains data specifying the initialization code for smart contract 804.

Smart contract 804 is a type of account existent only within the blockchain execution environment. Smart contract 804 is not associated with an external account, but rather is a notional object stored that resides at a specific address on the blockchain. Smart contract 804 includes both code, i.e. functions, and data, i.e. state. Smart contract 804 has direct control over its own state and storage memory to preserve persistent state variables. When referenced, either through a transaction or due to the internal execution of code, smart contract 804 executes its associated functions.

Smart contracts have a number of desirable properties. Execution of the smart contract is managed automatically by the network. Documents are encrypted on a shared ledger that is duplicated many times over on different nodes of the network, ensuring that the data is true and correct. Because smart contracts on distributed ledgers cannot be modified, they provide an immutable record of submitted workflow transactions that is highly resistant to post-transaction changes.

Transaction 802 contains data specifying initialization code for smart contract 804. Each account in a blockchain network executes this initialization code to incorporate smart contract 804 into the blockchain. At creation smart contract 804, initialization code is executed to retrieve the associated functions of smart contract 804, after which the initialization code can be discarded.

In operation 900 shown in FIG. 9, smart contract 804 generates message 902. Message 902 is an instruction constructed by smart contract 804 in response to receiving a message. Because smart contract 804 exists only within the blockchain execution environment, message 902 is a sort of “virtual transaction” sent by code from one account to another.

Message 902 can specify input data that results in message calls for other accounts, allowing smart contract 804 to read and write to internal storage. Alternatively, message 902 can contain data specifying initialization code, allowing smart contract 804 to create additional smart contracts.

The associated functions of smart contract 804 can be executed as part of state transition and block validation. If a transaction is added into a block, the code execution spawned by that transaction will be executed by all accounts that download and validate the block.

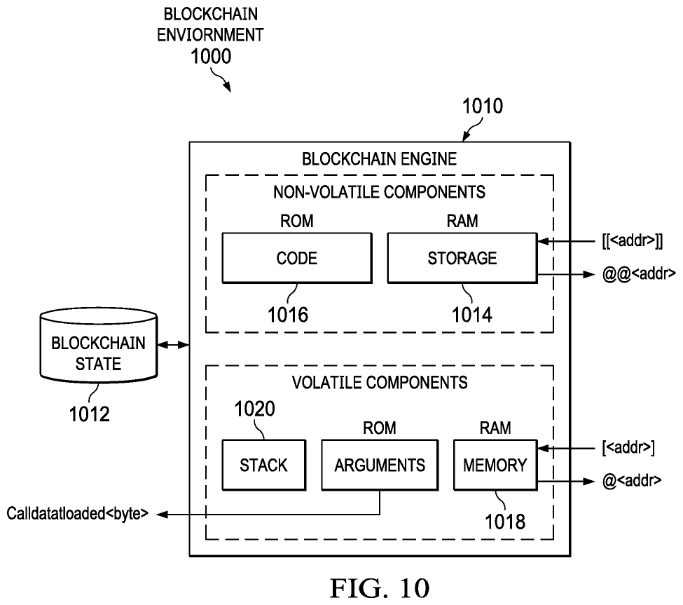

With reference next to FIG. 10, a block diagram of an execution environment for executing a smart contract stored on the blockchain is depicted in accordance with an illustrative embodiment.

Blockchain environment 1000 includes a number of different components. As depicted, blockchain environment 1000 includes blockchain engine 1010 and blockchain state 1012.

Blockchain engine 1010 is responsible for the internal account state and transaction computation for the blockchain. Blockchain engine 1010 performs state transitions for smart contracts. In this illustrative example, blockchain engine 1010 is a stack-based architecture that uses a last-in, first-out stack. Blockchain engine 1010 executes transactions recursively, computing the system state and the machine state for each loop. Blockchain engine 1010 includes non-volatile and volatile components.

Storage 1014 is non-volatile and maintained on the blockchain as part of the system state. Every smart contract on the blockchain has its own storage. Storage 1014 preserves all the state variables for the smart contract that do not change between the function calls.

Code 1016 are the functions associated with smart contract 804. Code 1016 are instructions that formally specify the meaning and ramifications of a transaction or message; code 1016 executes in response to receiving a message call. Code 1016 is stored in a virtual ROM that cannot be changed after construction. Blockchain engine 1010 executes code 1016 in response to a message call to the smart contract.

Memory 1018 is volatile and cleared between external function calls. Memory 1018 stores temporary data, such as: function arguments, local variables, and return values. Stack 1020 is used to hold temporary values when conducting calculations in blockchain engine 1010.

Blockchain environment 1000 includes blockchain state 1012. Blockchain state 1012 is combined state of all accounts that have interacted with the blockchain, mapping blockchain addresses to accounts and account states. Blockchain state 1012 may not be stored on the blockchain, but rather in a data structure on a backend state database that maintains the mapping. Blockchain engine 1010 relies on blockchain state 1012 for execution of certain instructions.

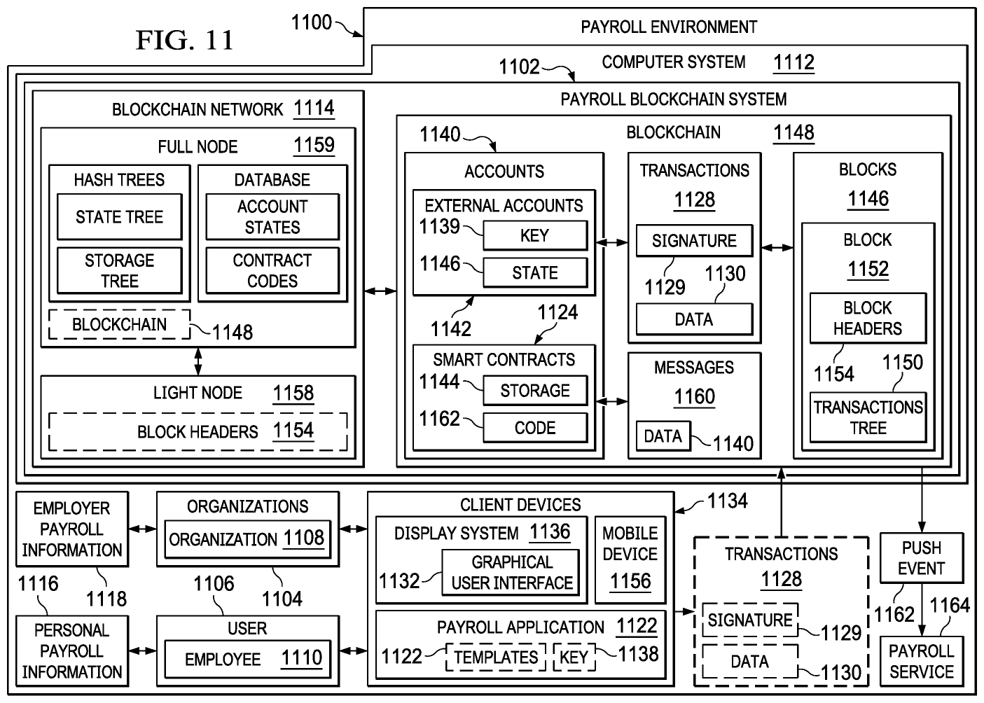

With reference now to FIG. 11, a block diagram of a blockchain timeclock environment is depicted in accordance with an illustrative embodiment. As depicted, payroll environment 1100 includes payroll blockchain system 1102.

Payroll blockchain system 1102 may take different forms. For example, payroll blockchain system 1102 may be selected from at least one of an employee information system, a research information system, a sales information system, an accounting system, a payroll system, a human resources system, or some other type of information system that records and stores time capture events and information.

As used herein, the phrase “at least one of,” when used with a list of items, means different combinations of one or more of the listed items may be used and only one of each item in the list may be needed. In other words, “at least one of” means any combination of items and number of items may be used from the list, but not all of the items in the list are required. The item may be a particular object, thing, or a category.

For example, and without limitation, “at least one of item A, item B, or item C” may include item A, item A and item B, or item B. This example also may include item A, item B, and item C or item B and item C. Of course, any combinations of these items may be present. In some illustrative examples, “at least one of” may be, for example, without limitation, two of item A; one of item B; and ten of item C; four of item B and seven of item C; or other suitable combinations.

In this illustrative example, payroll blockchain system 1102 manages payroll information for organizations 1104 and users 1106. Organizations 1104 is one or more organization, such as organization 1108. Organization 1108 may be, for example, a corporation, a partnership, a charitable organization, a city, a government agency, or some other suitable type of organization. Organization 1108 can encompass people who are employed by or associated with organization 1108, such as employee 1110. Users 1106 can be an employee of one or more organizations 1104.

In this illustrative example payroll blockchain system 1102 is implemented in computer system 1112. Computer system 1112 is a physical hardware system and includes one or more data processing systems. When more than one data processing system is present, those data processing systems may be in communication with each other using a communications medium. The communications medium may be a network. The data processing systems may be selected from at least one of a computer, a server computer, a workstation, a tablet computer, a laptop computer, a mobile phone, or some other suitable data processing system. The data processing systems in the network of data processing systems are nodes within blockchain network 1114.

Payroll blockchain system 1102 may be implemented in software, hardware, firmware, or a combination thereof. When software is used, the operations performed by payroll blockchain system 1102 may be implemented in program code configured to run on hardware, such as a processor unit. When firmware is used, the operations performed by payroll blockchain system 1102 may be implemented in program code and data and stored in persistent memory to run on a processor unit. When hardware is employed, the hardware may include circuits that operate to perform the operations in payroll blockchain system 1102.

In the illustrative examples, the hardware may take the form of a circuit system, an integrated circuit, an application-specific integrated circuit (ASIC), a programmable logic device, or some other suitable type of hardware configured to perform a number of operations. With a programmable logic device, the device may be configured to perform the number of operations. The device may be reconfigured at a later time or may be permanently configured to perform the number of operations. Programmable logic devices include, for example, a programmable logic array, programmable array logic, a field programmable logic array, a field programmable gate array, and other suitable hardware devices. Additionally, the processes may be implemented in organic components integrated with inorganic components and may be comprised entirely of organic components, excluding a human being. For example, the processes may be implemented as circuits in organic semiconductors.

In this illustrative example, payroll blockchain system 1102 manages payroll information for organizations 1104 and users 1106. The distributed computing and trust enabled by payroll blockchain system 1102 allows users 1106 greater control over payroll processing by giving users 1106 control of personal payroll information 1116.

Personal payroll information 1116 is data about users 1106 that can be used to run payroll services for organizations 1104. For example, personal payroll information 1116 may include personally identifying information about users 1106, such as at least one of a name, a date of birth, a social security number, an address, a telephone number, an e-mail address, a driver's license number, a passport number and country of issuance, an alien registration number, a customs admission number, and a professional license number, as well as possibly other relevant personal information that can be used to run payroll services. Personal payroll information 1116 may also include relevant tax-related information for users 1106, such as at least one of marital tax filing status, personal tax allowances, and personal tax credits, as well as possibly other relevant tax-related information. Personal payroll information 1116 may also include relevant benefit participation in elections for users 1106, such as at least one of retirement plan elections, stock option elections, medical plan elections, and dental plan elections as well as possibly other relevant benefit participation information that can be elected by users 1106. In addition, personal payroll information 1116 may include direct deposit information, such as bank account and routing numbers.

In contrast to personal payroll information 1116, employer payroll information 1118 is information about organizations 1104, employees of organizations 1104, and payroll policies of organizations 1104 that can be used to run payroll services. For example, information about organizations 1104 may include at least one of an organization name, an organization address, and an employer identification number (EIN), as well as possibly other relevant information. Information about employees of organizations 1104 may include at least one of an employee name, an employee date of birth, an employee social security number, and an employee salary, as well as possibly other relevant information.

Information about payroll policies of organizations 1104 comprises one or more rules that define how payroll should be run for employee 1110 of each of organizations 1104. Information about payroll policies can include information about a health plan policy, a regular pay policy, a union policy, a retirement savings policy, a pension policy, and an overtime policy, as well as information about some other suitable type of policy.

Organizations 1104 and users 1106 can record payroll information in blockchain 1148 by using payroll application 1122 to create one or more smart contracts 1124. In an employer context, Organizations 1104 can enter employer payroll information 1118 using one or more templates 1126. Payroll application 1122 submits transaction 1128 that includes data 1130 for creating one of smart contracts 1124 based on employer payroll information 1118. Similarly, in an employee context, users 1106 can enter personal payroll information 1116 using one or more templates 1126. Payroll application 1122 submits transaction 1128 that includes data 1130 for creating one of smart contracts 1124 based on personal payroll information 1116.

Organizations 1104 and Users 1106 interact with payroll application 1122 through user input to graphical user interface 1132 using one or more user input devices, such as a keyboard, a mouse, a graphical user interface (a physical display), a touch screen, a voice interaction, and any other suitable interface for interacting with the computer.

In one illustrative example, client devices 1134 displays graphical user interface 1132 on display system 1136. In this illustrative example, display system 1136 can be a group of display devices. A display device in display system 1136 may be selected from one of a liquid crystal display (LCD), a light emitting diode (LED) display, an organic light emitting diode (OLED) display, and other suitable types of display devices.

Payroll blockchain system 1102 receives transaction 1128 from one of external accounts 1142. External accounts 1142 are examples of accounts 204 shown in block form in FIG. 2. External accounts 1142 allow external actors, such as organizations 1104 and users 1106 to interact with blockchain 1148 by issuing templates 1126, and signed using key 1138.

Transactions 1128 submitted from external accounts 1142 are cryptographically-signed to uniquely identify a particular account that is associated with the unique key 1139 for that account. For example, payroll blockchain system 1102 is able to uniquely identify which of organizations 1104, and users 1106, issue transactions 1128 signed using key 1138. Based on the unique signature 1129 created, each node in block chain network 1114 can use the corresponding key 1139 to identify the corresponding one of external accounts 1142.

In this illustrative example, transaction 1128 is a “contract-creation” transaction that includes data 1130 specifying initialization code for one of smart contracts 1124. Additionally, Data 1140 can specify input data for one or more of smart contracts 1124 data 1130 by including payroll information entered into one or more templates 1126. Once created, smart contracts 1124 store payroll information in its associated storage 1144 as part of the smart contract's associated state.

Payroll blockchain system 1102 records transactions 1128 in blocks 1146 of blockchain 1148. Each of transactions 1128 is hashed and stored in transactions hash tree 1150 of associated block 1152. All of the transaction hashes in transactions hash tree 1150 are themselves hashed and stored as a root hash as part of block headers 1154.

Block headers 1154 are much smaller than entire blocks. Using a distributed hash table as a database, mobile device 1156 can operate as light client node 1158 that stores just block headers 1154 of blockchain 1148. Light client node 1158 can obtain blockchain information by communicating with trusted full node 1159. Light client node 1158 allow users in storage-limited or bandwidth-limited environments, such as in applications on a mobile device 1156, to maintain a high-security assurance about a current state of some portion of the state of blockchain 1148, or verify the execution of transactions 1128.

In this illustrative example, smart contracts 1124 can generate one or more messages 1160 in response to the execution of code 1162. Messages 1160 can be sent to other accounts 1140, including external accounts 1142 and other smart contracts 1124. For example, a first one of smart contracts 1124 that is associated with organization 1108 may generate messages 1160 addressed to the second one of smart contracts 1124 that is associated with employee 1110. In response, the second smart contract may return personal payroll information 1116 from storage 1144 of the second smart contract. In this manner, smart contracts 1124 enable the use of personal payroll information 1116 of employee 1110 to provide payroll services.

Additionally, messages 1160 generated by smart contracts 1124 can request external accounts 1142 to generate external events, such as push event 1162. Push event 1162 can be, for example, a web hook, a web socket, or some other appropriate communication that communicates timeclock information to an external service, such as payroll service 1164.

For example, payroll blockchain system 1102 associates a URL address for payroll service 1164 with the account of the organization 1108 in payroll blockchain system 1102. Payroll blockchain system 1102 pushes a POST request to payroll service 1164. The POST request can comprise a JSON object that includes payroll information to run payroll services for organization 1108.

In this illustrative example, payroll service 1164 is associated with an account, such as one of external accounts 1142, of a payroll service provider. Payroll blockchain system 1102 communicates payroll information to payroll service 1164 through push event 1162. In this illustrative example, push event 1162 communicates payroll information to payroll service 1164, enabling payroll service 1164 to use payroll information to provide payroll services for one or more of organizations 1104 and users 1106.

In one illustrative example, payroll service 1164 automatically provides payroll services upon the occurrence of certain conditions specified in one or more of smart contracts 1124. Once the conditions are met for the payroll, one or more of smart contracts 1124 on the blockchain are triggered. Execution of one or more of smart contracts 1124 not only identify relevant information for processing payroll, but also indicate information on how much, and where to pay to the various parties in a payroll transaction.

Payroll service 1164 processes payroll based on the information separately maintained in the different smart contracts 1124. Upon processing of payroll, all parties (including the government, any third party, and the employee) are paid, and the transaction is recorded in blockchain 1148.

For example, one or more of smart contracts 1124 can specify conditions for processing payroll based on date (e.g., 15th of the month and end of the month); processing payroll can be triggered by an approval condition (e.g., “yes” or “no”). Or no with no additional parameter with all the payment details already in the blockchain), or it can be an approval with additional parameter (hours worked, amount to be paid, etc.)

The illustrative example in FIG. 11 and the examples in the other subsequent figures provide one or more technical solutions that address one or more technical problems that only exists in computers, particularly a network-centric system of computers. Specifically, payroll blockchain system 1102 provides an immutable record of payroll information. In this manner, the use of payroll blockchain system 1102 has a technical effect of providing payroll services using blockchain 1148, thereby reducing time, effort, or both in accurate and extensive record-keeping necessary for organizations 1104 to effectively maintain records of employees' personal payroll information 1116. By separately managing personal payroll information 1116 and employer payroll information 1118, payroll blockchain system 1102 enables a reusable employee profile that can be used by payroll service 1164 regardless of employment changes among employees and employers. The distributed computing and trust enabled by payroll blockchain system 1102 allows users 1106 greater control over payroll processing by giving users 1106 control of personal payroll information 1116.

As a result, computer system 1112 operates as a special purpose computer system; in which payroll blockchain system 1102 in computer system 1112 uses smart contracts 1124 to separately manage personal payroll information 1116 of users 1106, and employer payroll information 1118 of organizations 1104. Payroll blockchain system 1102 records a payroll service's smart contract on a payroll block chain. The payroll service's smart contract indicates an employer, and at least one condition for processing payroll for the employer. In response to occurrence of the condition for processing payroll for the employer, Payroll blockchain system 1102 identifies employer payroll information recorded in an employer smart contract on the payroll blockchain. Payroll blockchain system 1102 identifies employee payroll information recorded in an employee smart contract on a payroll blockchain. Furthermore, payroll blockchain system 1102 processes payroll for the employer based on the employer payroll information recorded in the employer smart contract, and the employee payroll information recorded in an employee smart contract.

Thus, payroll blockchain system 1102 transforms computer system 1112 into a special purpose computer system as compared to currently available general computer systems that do not have payroll blockchain system 1102. Currently used general computer systems do not provide an immutable record of payroll information, that reduces the time, effort, or both in the accurate and extensive record-keeping necessary to effectively maintain records of employees' personal payroll information 1116. The distributed computing and trust enabled by payroll blockchain system 1102 allows users 1106 greater control over payroll processing by giving users 1106 control of personal payroll information 1116.

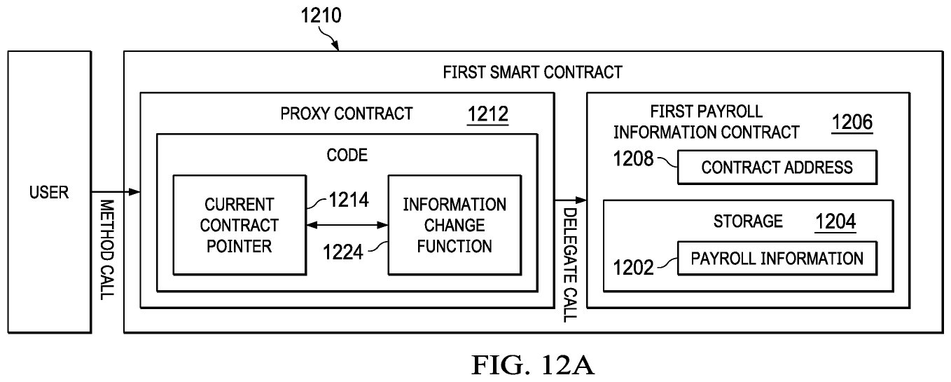

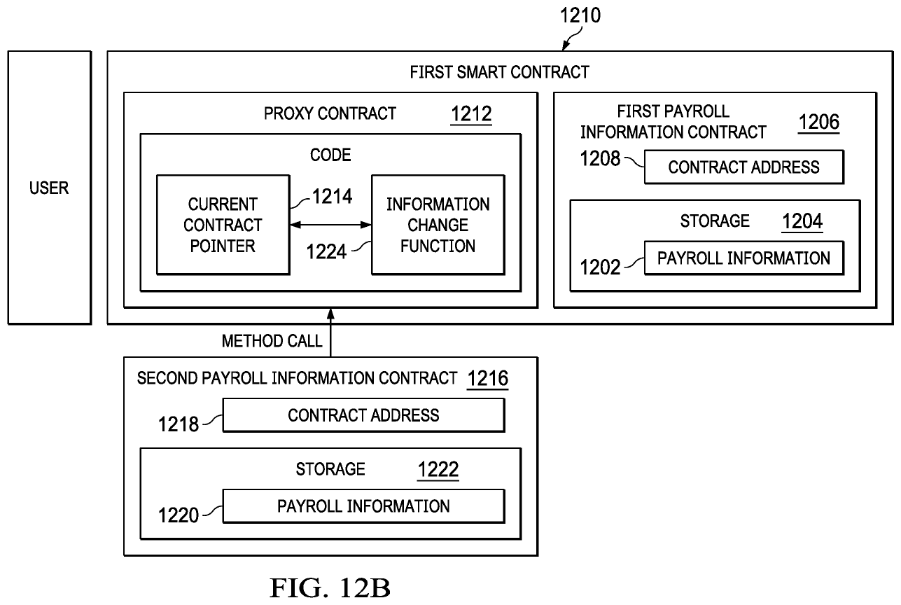

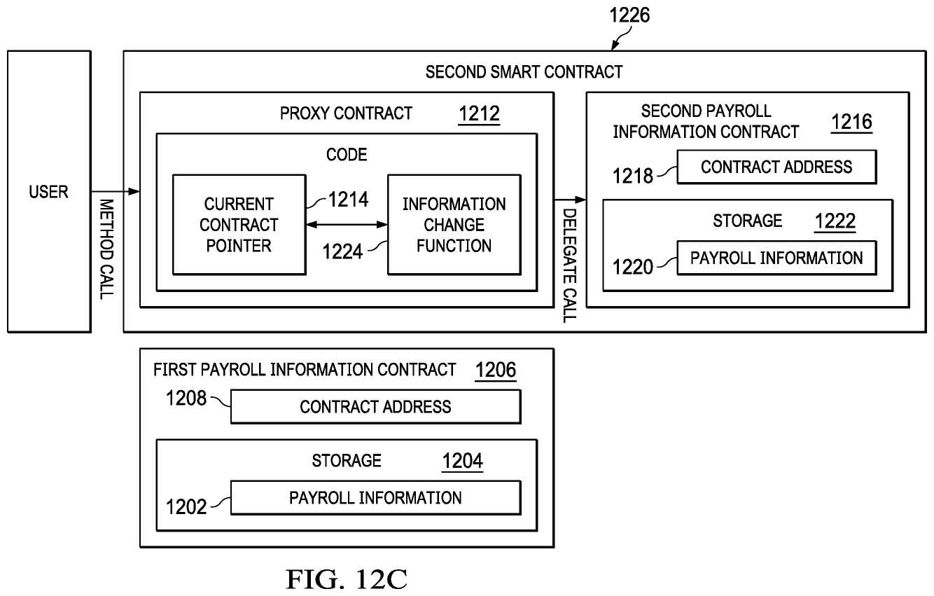

With reference next to FIGS. 12A-12C, a series of block diagrams illustrate a data flow for updating payroll information. The data flows of FIGS. 12A-12C can be implemented in payroll blockchain system 1102 of FIG. 11.

Referring now specifically to FIG. 12A, payroll information 1202 is held in storage 1204 of first payroll information contract 1206. First payroll information contract 1206 is a smart contract such as one of smart contracts 1124 of FIG. 11. Payroll information 1202 can be personal payroll information 1116 for users 1106, both shown in block form in FIG. 11. Alternatively, payroll information 1202 can be employer payroll information 1118 for organization 1108, both shown in block form in FIG. 11. First payroll information contract 1206 is located at contract address 1208 on block chain, such as blockchain 1148 of FIG. 11.

In this illustrative example, first smart contract 1210 is comprised of both first payroll information contract 1206 and a proxy contract 1212. Proxy contract 1212 delegate calls to first payroll information contract 1206, as indicated by current contract pointer 1214. First payroll information contract 1206 executes within the context of proxy contract 1212. Proxy contract 1212 can access payroll information 1202 in storage 1204 of first payroll information contract 1206 while preserving the message sender and message values of the original message call. Both proxy contract 1212 and first payroll information contract 1206 can be created during contract creation of a first smart contract 1210.

With reference now to FIG. 12B, second payroll information contract 1216 is generated when a user desires to make a change to payroll information 1202. Second payroll information contract 1216 is located at contract address 1218 on a blockchain. Second payroll information contract 1216 holds payroll information 1220 in storage 1222. Payroll information 1220 can be personal payroll information 1116 for users 1106, both shown in block form in FIG. 11. Alternatively, payroll information 1220 can be employer payroll information 1118 for organization 1108, both shown in block form in FIG. 11. In this illustrative example, payroll information 1220 includes one or more changes to payroll information 1202.

As part of contract-creation of second payroll information contract 1216, a method call is sent to proxy contract 1212, passing contract address 1218 and invoking information change function 1224. Information change function 1224 updates current contract pointer 1214, changing the address indicated in proxy contract 1212 to point to contract address 1218 of second employee payroll information contract 1216.

Referring now specifically to FIG. 12C, after updating the current contract pointer 1214, second smart contract 1226 is comprised of both proxy contract 1212 and second payroll information contract 1216. Proxy contract 1212 delegates method calls to second payroll information contract 1216, as indicated by current contract pointer 1214. Second payroll information contract 1216 executes within the context of proxy contract 1212. Because message calls delegated to second payroll information contract 1216 preserving the message sender and message values of the original message call, second smart contract 1226 appears to have the same block chain address as first smart contract 1210.

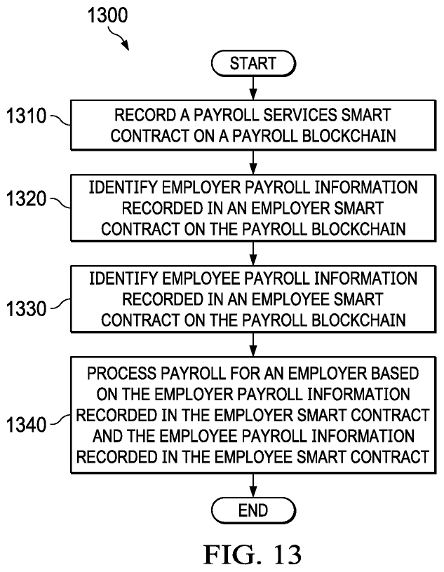

With reference next to FIG. 13, a flowchart of a process for providing payroll services by separately managing payroll information for employers and employees is depicted in accordance with an illustrative embodiment. The process of FIG. 13 can be a software process implemented in one or more components of payroll blockchain system 1102 of FIG. 11.

Process 1300 begins by recording a payroll services smart contract on a payroll blockchain (step 1310). The payroll service the smart contract can be a contract such as one of smart contracts 1124 of FIG. 11. In one illustrative example, the payroll services smart contract indicates an employer, and at least one condition for processing payroll for the employer.

In response to occurrence of the condition for processing payroll for the employer, process 1300 then identifies employer payroll information recorded in an employer smart contract on a payroll blockchain (step 1320). The employer payroll information can be can be employer payroll information 1118 and recorded in one or more smart contracts 1124, both shown in block form in FIG. 11.

Process 1300 then identifies employee payroll information recorded in an employee smart contract on the payroll blockchain (step 1330). The employee payroll information can be personal payroll information 1116 recorded in one or more smart contracts 1124, both shown in block form in FIG. 11.

Afterwards, process 1300 processes payroll for the employer based on the employer payroll information recorded in the employer smart contract and the employee payroll information recorded in the employee smart contract (step 1340), with the process terminating thereafter.

The flowcharts and block diagrams in the different depicted embodiments illustrate the architecture, functionality, and operation of some possible implementations of apparatuses and methods in an illustrative embodiment. In this regard, each block in the flowcharts or block diagrams may represent at least one of a module, a segment, a function, or a portion of an operation or step. For example, one or more of the blocks may be implemented as program code, hardware, or a combination of the program code and hardware. When implemented in hardware, the hardware may, for example, take the form of integrated circuits that are manufactured or configured to perform one or more operations in the flowcharts or block diagrams. When implemented as a combination of program code and hardware, the implementation may take the form of firmware. Each block in the flowcharts or the block diagrams may be implemented using special purpose hardware systems that perform the different operations or combinations of special purpose hardware and program code run by the special purpose hardware.

In some alternative implementations of an illustrative embodiment, the function or functions noted in the blocks may occur out of the order noted in the figures. For example, in some cases, two blocks shown in succession may be performed substantially concurrently, or the blocks may sometimes be performed in the reverse order, depending upon the functionality involved. Also, other blocks may be added in addition to the illustrated blocks in a flowchart or block diagram.

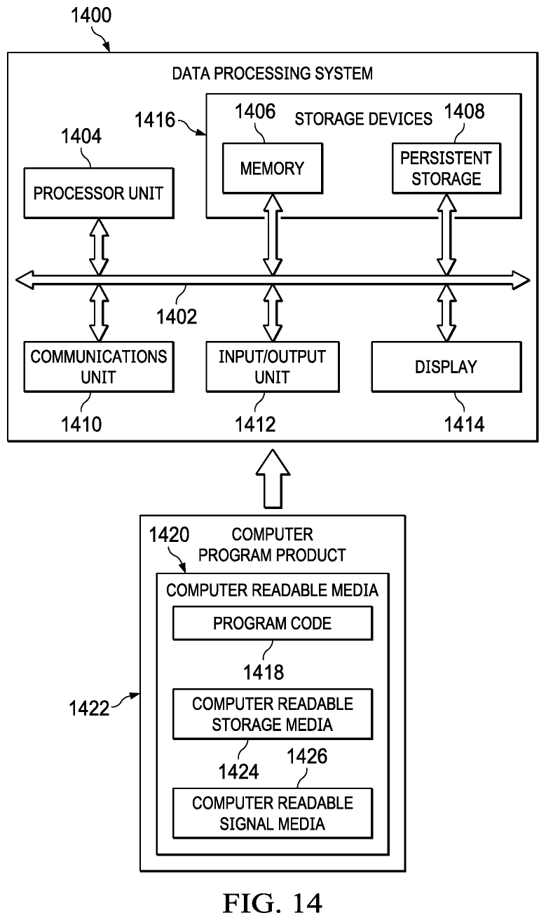

Turning now to FIG. 14, an illustration of a block diagram of a data processing system is depicted in accordance with an illustrative embodiment. Data processing system 1400 may be used to implement computer system 1108 and other data processing systems that may be used in payroll environment 1100 in FIG. 11.

In this illustrative example, data processing system 1400 includes communications framework 1402, which provides communications between processor unit 1404, memory 1406, persistent storage 1408, communications unit 1410, input/output (I/O) unit 1428, and display 1414. In this example, communications framework 1402 may take the form of a bus system.

Processor unit 1404 serves to execute instructions for software that may be loaded into memory 1406. Processor unit 1404 may be a number of processors, a multi-processor core, or some other type of processor, depending on the particular implementation.

Memory 1406 and persistent storage 1408 are examples of storage devices 1416. A storage device is any piece of hardware that is capable of storing information, such as, for example, without limitation, at least one of data, program code in functional form, or other suitable information either on a temporary basis, a permanent basis, or both on a temporary basis and a permanent basis. Storage devices 1416 may also be referred to as computer readable storage devices in these illustrative examples. Memory 1406, in these examples, may be, for example, a random access memory or any other suitable volatile or non-volatile storage device. Persistent storage 1408 may take various forms, depending on the particular implementation.

For example, persistent storage 1408 may contain one or more components or devices. For example, persistent storage 1408 may be a hard drive, a solid state hard drive, a flash memory, a rewritable optical disk, a rewritable magnetic tape, or some combination of the above. The media used by persistent storage 1408 also may be removable. For example, a removable hard drive may be used for persistent storage 1408.

Communications unit 1410, in these illustrative examples, provides for communications with other data processing systems or devices. In these illustrative examples, communications unit 1410 is a network interface card.

Input/output unit 1412 allows for input and output of data with other devices that may be connected to data processing system 1400. For example, input/output unit 1412 may provide a connection for user input through at least one of a keyboard, a mouse, or some other suitable input device. Further, input/output unit 1412 may send output to a printer. Display 1414 provides a mechanism to display information to a user.

Instructions for at least one of the operating system, applications, or programs may be located in storage devices 1416, which are in communication with processor unit 1404 through communications framework 1402. The processes of the different embodiments may be performed by processor unit 1404 using computer-implemented instructions, which may be located in a memory, such as memory 1406.

These instructions are referred to as program code, computer usable program code, or computer readable program code that may be read and executed by a processor in processor unit 1404. The program code in the different embodiments may be embodied on different physical or computer readable storage media, such as memory 1406 or persistent storage 1408.

Program code 1418 is located in a functional form on computer readable media 1420 that is selectively removable and may be loaded onto or transferred to data processing system 1400 for execution by processor unit 1404. Program code 1418 and computer readable media 1420 form computer program product 1422 in these illustrative examples. In one example, computer readable media 1420 may be computer readable storage media 1424 or computer readable signal media 1426.

In these illustrative examples, computer readable storage media 1424 is a physical or tangible storage device used to store program code 1418 rather than a medium that propagates or transmits program code 1418.

Alternatively, program code 1418 may be transferred to data processing system 1400 using computer readable signal media 1426. Computer readable signal media 1426 may be, for example, a propagated data signal containing program code 1418. For example, computer readable signal media 1426 may be at least one of an electromagnetic signal, an optical signal, or any other suitable type of signal. These signals may be transmitted over at least one of communications links, such as wireless communications links, optical fiber cable, coaxial cable, a wire, or any other suitable type of communications link.

The different components illustrated for data processing system 1400 are not meant to provide architectural limitations to the manner in which different embodiments may be implemented. The different illustrative embodiments may be implemented in a data processing system including components in addition to or in place of those illustrated for data processing system 1400. Other components shown in FIG. 14 can be varied from the illustrative examples shown. The different embodiments may be implemented using any hardware device or system capable of running program code 1418.

The description of the different illustrative embodiments has been presented for purposes of illustration and description and is not intended to be exhaustive or limited to the embodiments in the form disclosed. The different illustrative examples describe components that perform actions or operations. In an illustrative embodiment, a component may be configured to perform the action or operation described. For example, the component may have a configuration or design for a structure that provides the component an ability to perform the action or operation that is described in the illustrative examples as being performed by the component.

Many modifications and variations will be apparent to those of ordinary skill in the art. Further, different illustrative embodiments may provide different features as compared to other desirable embodiments. The embodiment or embodiments selected are chosen and described in order to best explain the principles of the embodiments, the practical application, and to enable others of ordinary skill in the art to understand the disclosure for various embodiments with various modifications as are suited to the particular use contemplated.

What is claimed is:

1. A method of providing payroll services by separately managing payroll information for employers and employees, the method comprising:
recording a payroll services smart contract on a payroll block chain, wherein the payroll services smart contract indicates an employer and at least one condition for processing payroll for the employer;
in response to occurrence of the condition for processing payroll for the employer:
identifying employer payroll information recorded in an employer smart contract on a payroll block chain;
identifying employee payroll information recorded in an employee smart contract on a payroll block chain; and
processing payroll for the employer based on the employer payroll information recorded in the employer smart contract and the employee payroll information recorded in an employee smart contract.

2. The method of claim 1 further comprising:
receiving a first transaction from a user, wherein the first transaction includes the employee payroll information for the user;
generating the employee smart contract based on the personal payroll information for the user; and
recording the employee smart contract in the payroll blockchain.

3. The method of claim 2, wherein the employee smart contract is a first employee smart contract, the method further comprising:
receiving a second transaction from the user, wherein the second transaction includes updated employee payroll information for the user;
generating a second employee smart contract based on the updated personal payroll information for the user; and
recording the second employee smart contract in the payroll blockchain.

4. The method of claim 3, wherein generating the first employee smart contract further comprises:
creating a proxy contract and an employee payroll information contract, wherein the proxy contract indicates a block chain address pointing to the employee payroll information contract;
wherein generating and recording the second employee smart contract in the payroll blockchain further comprises:
generating a second employee payroll information contract based on the updated personal payroll information for the user; and
recording the second employee payroll information contract in the payroll blockchain; and
updating the block chain address indicated in the proxy contract to point to the second employee payroll information contract.

5. The method of claim 1 further comprising:
receiving a first transaction from an organization, wherein the first transaction includes the employer payroll information for the organization;
generating the employer smart contract based on the employer payroll information for the organization; and
recording the employer smart contract in the payroll blockchain.

6. The method of claim 2, wherein the employer smart contract is a first employer smart contract, the method further comprising:
receiving a second transaction from the organization, wherein the second transaction includes updated employer payroll information for the organization;
generating a second employer smart contract based on the updated employer payroll information for the organization; and
recording the second employer smart contract in the payroll blockchain.

7. The method of claim 3, wherein generating the first employer smart contract further comprises:
creating a proxy contract and an employer payroll information contract, wherein the proxy contract indicates a block chain address pointing to the employer payroll information contract;
wherein generating and recording the second employer smart contract in the payroll blockchain further comprises:
generating a second employer payroll information contract based on the updated employer payroll information for the user; and
recording the second employer payroll information contract in the payroll blockchain; and
updating the block chain address indicated in the proxy contract to point to the second employer payroll information contract.

8. A computer system comprising:
the hardware processor; and
a payroll block chain system for providing payroll services by separately managing payroll information for employers and employees, wherein the payroll block chain system:
records a payroll services smart contract on a payroll block chain, wherein the payroll services smart contract indicates an employer and at least one condition for processing payroll for the employer; and
in response to occurrence of the condition for processing payroll for the employer:
identifies employer payroll information recorded in an employer smart contract on a payroll block chain;
identifies employee payroll information recorded in an employee smart contract on a payroll block chain; and
processes payroll for the employer based on the employer payroll information recorded in the employer smart contract and the employee payroll information recorded in an employee smart contract.

9. The computer system of claim 8, wherein the payroll block chain system further:
receives a first transaction from a user, wherein the first transaction includes the employee payroll information for the user;
generates the employee smart contract based on the personal payroll information for the user; and
records the employee smart contract in the payroll blockchain.

10. The computer system of claim 9, wherein the employee smart contract is a first employee smart contract, wherein the payroll block chain system further:
receives a second transaction from the user, wherein the second transaction includes updated employee payroll information for the user;
generates a second employee smart contract based on the updated personal payroll information for the user; and
records the second employee smart contract in the payroll blockchain.

11. The computer system of claim 10, wherein in generating the first employee smart contract, the payroll block chain system further:
creates a proxy contract and an employee payroll information contract, wherein the proxy contract indicates a block chain address pointing to the employee payroll information contract;
wherein in generating and recording the second employee smart contract in the payroll blockchain, the payroll block chain system further:
generates a second employee payroll information contract based on the updated personal payroll information for the user; and
records the second employee payroll information contract in the payroll blockchain; and
updates the block chain address indicated in the proxy contract to point to the second employee payroll information contract.

12. The computer system of claim 8, wherein the payroll block chain system further:
receives a first transaction from an organization, wherein the first transaction includes the employer payroll information for the organization;
generates the employer smart contract based on the employer payroll information for the organization; and
records the employer smart contract in the payroll blockchain.

13. The computer system of claim 12, wherein the employer smart contract is a first employer smart contract, the payroll block chain system further:
receives a second transaction from the organization, wherein the second transaction includes updated employer payroll information for the organization;
generates a second employer smart contract based on the updated employer payroll information for the organization; and
records the second employer smart contract in the payroll blockchain.

14. The computer system of claim 13, wherein in generating the first employer smart contract, the payroll block chain system further:
creates a proxy contract and an employer payroll information contract, wherein the proxy contract indicates a block chain address pointing to the employer payroll information contract;
wherein in generating and recording the second employer smart contract in the payroll blockchain, the payroll block chain system further:
generates a second employer payroll information contract based on the updated employer payroll information for the user; and
records the second employer payroll information contract in the payroll blockchain; and
updates the block chain address indicated in the proxy contract to point to the second employer payroll information contract.

15. A computer program product for providing payroll services by separately managing payroll information for employers and employees, the computer program product comprising:
a non-transitory computer readable storage media;
program code, stored on the computer readable storage media, for recording a payroll services smart contract on a payroll block chain, wherein the payroll services smart contract indicates an employer and at least one condition for processing payroll for the employer; and
program code, stored on the computer readable storage media, in response to occurrence of the condition for processing payroll for the employer:
for identifying employer payroll information recorded in an employer smart contract on a payroll block chain;
for identifying employee payroll information recorded in an employee smart contract on a payroll block chain; and
for processing payroll for the employer based on the employer payroll information recorded in the employer smart contract and the employee payroll information recorded in an employee smart contract.

16. The computer program product of claim 15 further comprising:
program code, stored on the computer readable storage media, for receiving a first transaction from a user, wherein the first transaction includes the employee payroll information for the user;
program code, stored on the computer readable storage media, for generating the employee smart contract based on the personal payroll information for the user; and
program code, stored on the computer readable storage media, for recording the employee smart contract in the payroll blockchain.

17. The computer program product of claim 16, wherein the employee smart contract is a first employee smart contract, the computer program product further comprising:
program code, stored on the computer readable storage media, for receiving a second transaction from the user, wherein the second transaction includes updated employee payroll information for the user;
program code, stored on the computer readable storage media, for generating a second employee smart contract based on the updated personal payroll information for the user; and
program code, stored on the computer readable storage media, for recording the second employee smart contract in the payroll blockchain.

18. The computer program product of claim 17, wherein program code for generating the first employee smart contract further comprises:
program code, stored on the computer readable storage media, for creating a proxy contract and an employee payroll information contract, wherein the proxy contract indicates a block chain address pointing to the employee payroll information contract;
wherein the program code for generating and recording the second employee smart contract in the payroll blockchain further comprises:
program code, stored on the computer readable storage media, for generating a second employee payroll information contract based on the updated personal payroll information for the user; and
program code, stored on the computer readable storage media, for recording the second employee payroll information contract in the payroll blockchain; and
program code, stored on the computer readable storage media, for updating the block chain address indicated in the proxy contract to point to the second employee payroll information contract.

19. The computer program product of claim 15 further comprising:
program code, stored on the computer readable storage media, for receiving a first transaction from an organization, wherein the first transaction includes the employer payroll information for the organization;
program code, stored on the computer readable storage media, for generating the employer smart contract based on the employer payroll information for the organization; and
program code, stored on the computer readable storage media, for recording the employer smart contract in the payroll blockchain.

20. The computer program product of claim 19, wherein the employer smart contract is a first employer smart contract, the computer program product further comprising:
program code, stored on the computer readable storage media, for receiving a second transaction from the organization, wherein the second transaction includes updated employer payroll information for the organization;
program code, stored on the computer readable storage media, for generating a second employer smart contract based on the updated employer payroll information for the organization; and
program code, stored on the computer readable storage media, for recording the second employer smart contract in the payroll blockchain.

21. The computer program product of claim 20, wherein the program code for generating the first employer smart contract further comprises:
program code, stored on the computer readable storage media, for creating a proxy contract and an employer payroll information contract, wherein the proxy contract indicates a block chain address pointing to the employer payroll information contract;
wherein the program code for generating and recording the second employer smart contract in the payroll blockchain further comprises:
program code, stored on the computer readable storage media, for generating a second employer payroll information contract based on the updated employer payroll information for the user; and
program code, stored on the computer readable storage media, for recording the second employer payroll information contract in the payroll blockchain; and
program code, stored on the computer readable storage media, for updating the block chain address indicated in the proxy contract to point to the second employer payroll information contract.
